(19) United States
(12) Patent Application Publication
(10) Pub. No.: US 2010/0042251 A1
(43) Pub. Date: Feb. 18, 2010

(54) Machine monitoring apparatus and method

(76) Inventor: Lawrence S. Miyasaka, St. Charles, MO (US)

Correspondence Address: DOUGLAS E. WARREN;ATTORNEY AT LAW, P.O. BOX 6727, CHESTERFIELD, MO, 63006, US

(21) Appl. No.: 12/228,941

(22) Filed: Aug. 18, 2008

(51) Int. Cl. G06F 7/00

(52) U.S. Cl. 700/222

(57) ABSTRACT

The present invention relates to an apparatus and method of monitoring a machine. A preferred embodiment of the present invention is used to monitor the operation of a mail insertion machine. The mail insertion machine is an automated mail insertion device that inserts mailing inserts into preaddressed mailing devices. In a preferred embodiment of the present invention, computer software and monitoring devices are used to provide images of the mailing insert and the preaddressed mailing device in a manner that allows an operator of the mail insertion machine to compare the recipient indicia of the mailing insert with the recipient indicia of the preaddressed mailing to verify that the correct mailing insert is being inserted into the correct, matching preaddressed mailing device.

### CROSS REFERENCE TO RELATED APPLICATIONS

Not applicable.

### STATEMENT REGARDING FEDERALLY SPONSORED RESEARCH

Not Applicable.

### BACKGROUND OF THE INVENTION

A substantial portion of communications in the business world is accomplished by sending mass communication devices such as letters to other businesses and to customers of businesses. Such mass communications can be related to the opening of a new business, the introduction of new products or services, a general change in business operations such as changes of address and changes in the officers of the business, and any other type of mass communication.

In most such mass communications, the communication device is a letter that is inserted into an envelope addressed to the recipient of the letter. Because these communications are usually mass communications that can included the preparation and mailing of hundreds or even thousands of letter, various types of machines have been invented to assemble the letters and envelopes in preparation for mass mailing. These types of machine are generally identified in the industry as “mail insertion machines.”

An example of one type of mail insertion machine can be found in the disclosure of U.S. Pat. No. 5,949,687. In that patent, the most common elements of a mail insertion machine are disclosed. Those common elements usually include a staging area for a preprinted letter inserts (27), a staging area for a preaddressed mailing device (67), and a mechanism for inserting the preprinted letter into the preaddressed mailing device. When the preprinted letter includes the name and mailing address of a particular recipient, and where the preaddressed mailing device includes the same name and address of the recipient, it is critical that the name and address of the recipient match the name and address of the recipient on the preaddressed mailing device when the preprinted letter is inserted by the mail insertion machine into the preaddressed mailing device. In general, the timing and correlation of the elements of the mail insertion machine work to keep the proper synchronization between the preprinted letters and the preaddressed mailing devices.

Because this synchronization process is critical to the proper operation of the mail insertion machine, those skilled in the art are aware that the entire mail insertion process should be monitored carefully to ensure the recipient addresses on the preprinted letters and the preaddressed mailing devices match. Several inventions have been developed that accomplish this monitoring process. For example, U.S. Pat. No. 5,127,640 discloses a method of ensuring proper collation between the a first item and an envelope. U.S. Pat. No. 6,370,445 also discloses a device for ensuring proper collation between an inserted item and an envelope wherein the device uses specially designed item identifiers to check proper matching of the elements to be combined. However, in these inventions, as well as other similar inventions and devices that have been conceived to monitor a mail insertion machine, the monitoring technique requires expensive and complicated monitoring components or is designed to function with the operation of only one machine or type of machine.

### SUMMARY OF THE INVENTION

The various embodiments of the present invention include configurations of a machine monitoring apparatus and method that is less complex than those in the prior art and which is readily adaptable to operate in conjunction with a wide variety of mail insertion machines. More specifically, the embodiments of the present invention provide a lower cost and adaptable machine monitoring system that provides a monitor screen for display of visual images of mailing inserts in conjunction with visual images of preaddressed mailing devices such that an operator of the mail insertion machine can compare the two displayed images to ensure that the correct mailing insert is being inserted into its matching mailing device. Although one method of accomplishing this task can include comparing the full name and address on the mailing insert to the full name and address on the mailing device to determine if those names and addresses substantially match, the several embodiments of the present invention can also allow the operator to compare other indicia on the mailing insert with indicia on the mailing device to determine if the mail insertion machine is functioning correctly. For example, the items to be compared from the mailing insert and the mailing device could be either the first name of the recipient, the last name of the recipient, parts of the mailing address, or even a unique symbol or phrase assigned to a specific recipient. In fact, it will be appreciated that anything on the mailing insert and the mailing device can be used for comparison as long as the selected item to be compared is sufficiently distinctive enough to allow the operator to determine that the mailing insert is being inserted into its correct mailing device. Similarly, it is also understood that while preferred embodiments refer to mailing inserts, the inserts need not be preprinted, but instead may have labels or other types of devices on the inserts. Finally, in a similar manner, the preaddressed mailing devices can include labels attached to the mailing device or the mailing devices can themselves be preprinted. In fact, the mailing devices can be any mailing or packaging device into which an insert can be placed as long as information related to the intended recipient of the insert is displayed on the mailing device.

### DESCRIPTION OF THE DRAWINGS

In the accompanying drawings which form part of the specification:

FIG. 1 is a schematic view of the configuration of one embodiment of the present invention;

FIG. 2 is a perspective view of one embodiment of the present invention;

FIG. 3 is a perspective view of a portion of a letter insertion machine that uses one embodiment of the present invention;

FIG. 3a is a second perspective view of a portion of a letter insertion machine that incorporates certain components of one embodiment of the present invention;

FIG. 4 is a plan view of a portion of a letter insertion machine that incorporates certain components of one embodiment of the present invention;

FIG. 5 is a perspective view of a portion of a letter insertion machine that incorporates certain components of one embodiment of the present invention;

FIG. 6 is a perspective view of a portion of a letter insertion machine that incorporates certain components of one embodiment of the present invention; and

FIG. 7 is a front view of a computer monitor displaying software that can be used in conjunction with one embodiment of the present invention.

Corresponding reference characters indicate corresponding parts throughout the several views of the drawings.

While embodiments of the present invention are illustrated in the above referenced drawings and in the following descriptions, it is understood that the embodiments shown are merely for purpose of illustration and that various changes in construction may be resorted to in the course of manufacture in order that the present invention may be utilized to fit the circumstances which may arise, without in any way departing from the spirit and intention of the present invention, which is to be limited only in accordance with the claims contained herein.

### DETAILED DESCRIPTION OF ONE PREFERRED EMBODIMENT

A mail insertion machine inserts a mailing insert into a mailing device such as a preaddressed envelope or preaddressed package. The mail insertion machine is functioning properly when the mailing insert is being properly inserted by the mail insertion machine into the mailing device that matches the mailing insert. In a preferred embodiment of the present invention, images of the mailing insert and the preaddressed mailing device are displayed on a computer system monitor in a manner that allows the mail insertion machine operator to compare the two images to determine if some indicia on the mailing insert matches similar indicia on the mailing device. If the selected indicia does not match, the operator can stop the mail insertion machine and adjust the machine such that the correct mailing insert is being inserted into the correct and matching mailing device.

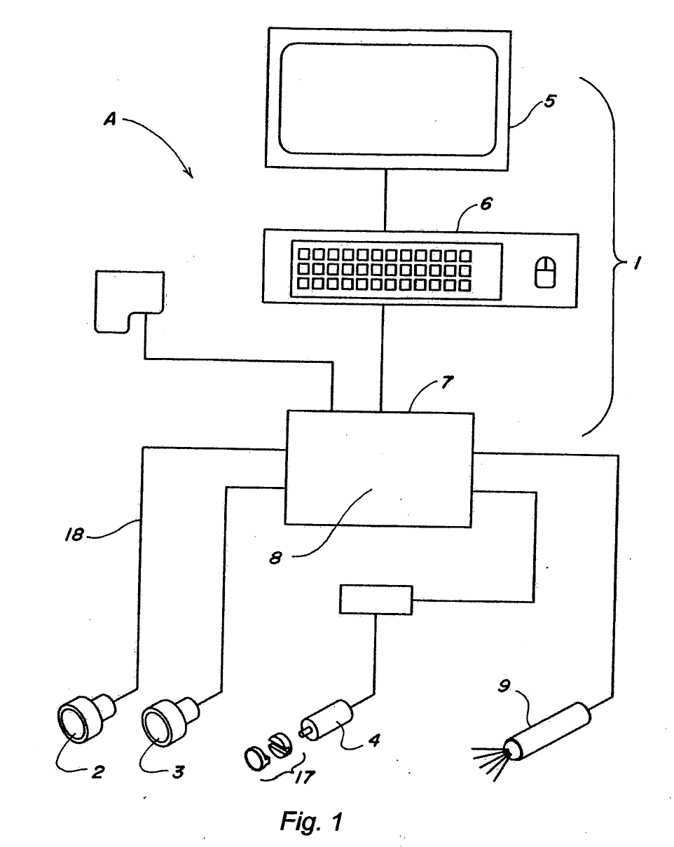

Referring now to FIG. 1, a preferred embodiment of the present invention relates to a machine monitoring apparatus A for use in conjunction with a mail insertion machine. The machine monitoring apparatus A of the present preferred embodiment generally comprises a computer system 1, a first camera 2, a second camera 3, and a machine cycle monitoring device 4. It is understood that the computer system 1 comprises a monitor 5, an input device 6, a microprocessor 7, and a computer software package 8. The machine cycle monitoring device 4 is capable of determining the operational position of a machine to be monitored wherein the machine cycle monitoring device is capable of providing information to the computer system 1 to thereby coordinate a set of monitoring images 28 for display on the monitor 5.

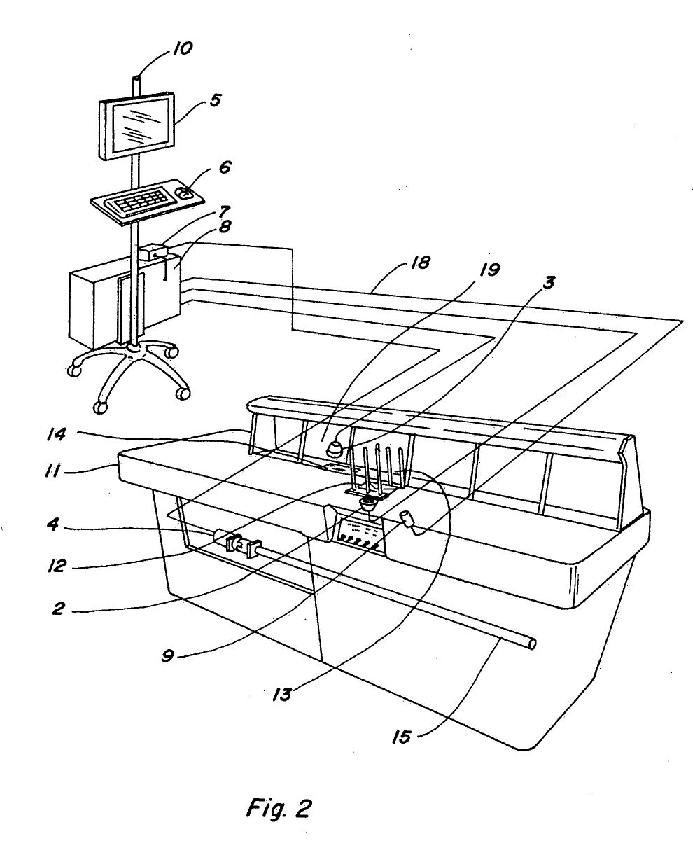

In alternative embodiments of the present invention, the machine monitoring apparatus A can optionally include at least one image illuminator 9 that can be incorporated into the system to provide the illumination required to properly display items detected by the first camera 2 and the second camera 3 on the monitor 5. In yet other alternative embodiments of the present invention, the computer monitor 5, the computer input device 6, and the microprocessor 7 can optionally be mounted on a stand 10 (FIG. 2).

Those of skill in the art will appreciate that the various embodiments of the machine monitoring apparatus A include necessary elements for allowing the various components of the machine monitoring apparatus A to communicate as necessary to accomplish the tasks as defined herein. In a preferred embodiment of the present invention, electrical conductors 18 such as wiring and cabling are used to allow communication between the components of the machine monitoring apparatus A. In other embodiments, however, other types of communication modes can be used while still remaining within the scope of the present invention. For example, the various element of other embodiments of the present invention can include the use of electromagnetic waves as the method communication between the elements of the machine monitoring apparatus A.

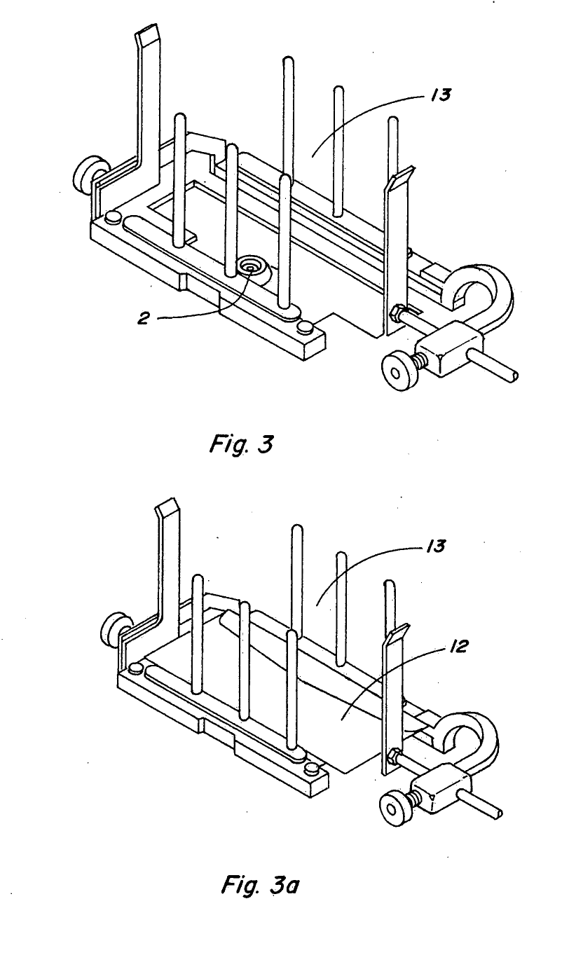

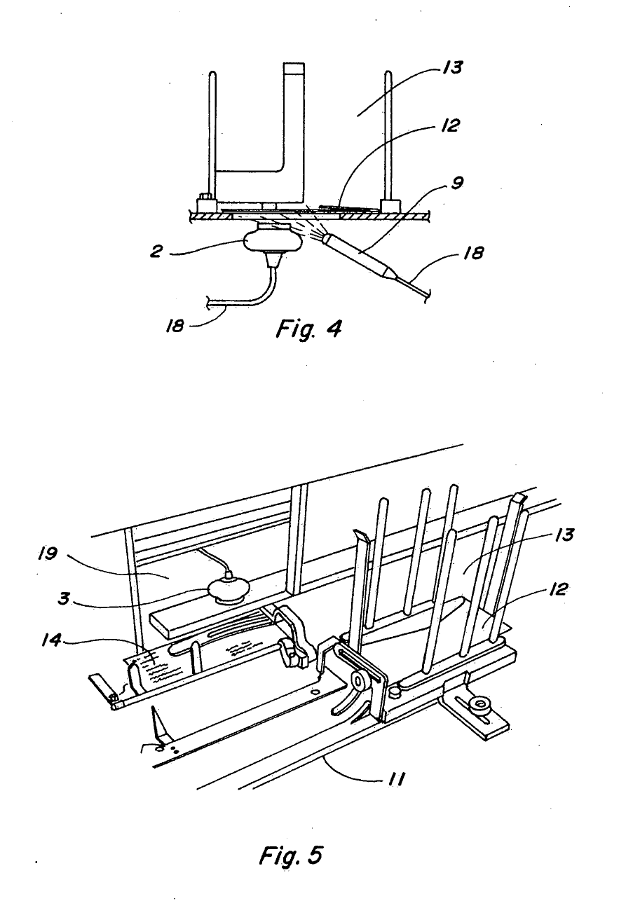

In a preferred embodiment, the machine monitoring apparatus A is generally installed on a typical mail insertion machine 11 as shown in FIG. 2. In that embodiment, the first camera 2 is installed in a manner that allows the camera to view a portion of a preaddressed mailing device 12 upon which a recipient indicia of the mailing device 31 (FIG. 7) related to a specific recipient is indicated. The recipient indicia related to a specific recipient can be a recipient's name, a recipient's address, a symbol assigned to a certain recipient, or any other indicia that is sufficiently distinctive enough to identify the recipient of the mailing device. It is understood that most mail insertion machines 11 (FIG. 2) have a staging area 13 in which the preaddressed mailing devices 12 are stored. It is also understood that in a typical mail insertion machine 11, the preaddressed mailing devices 12 are stored in the envelope staging area 13 such that the preaddressed mailing devices are face down in the staging area and that the preaddressed mailing devices are removed from the envelope staging area by removing the bottom preaddressed mailing device first (FIG. 3a). It is for this reason that the first camera 2 (FIG. 3 & FIG. 4) is positioned beneath the staging area 13 and will generally be pointed upward to read the front surface of the preaddressed mailing device 12. It is noted that in alternative embodiments of the machine monitoring apparatus A, the first camera 2 (FIG. 2) and the second camera 3 can be either fixedly mounted or adjustably mounted on the mail insertion machine 11 and that any type of bracket or holding tool can be used with any camera of the machine monitoring apparatus A and still remain within the scope of the present invention.

It will also be appreciated that in some installations, the lighting available in the area of the mail insertion machine 11 where the preaddressed mailing devices 12 are stored may not have enough illumination to allow the first camera 2 to read the front surface of the preaddressed mailing device. When such circumstances are found, a preferred embodiment of the machine monitoring apparatus A can include an illumination source 9 (FIG. 4). The illumination source 9 is positioned within or on the mail insertion machine 11 such that the illumination source can illuminate the front surface of the preaddressed mailing device 12 upon which the recipient indicia 31 (FIG. 7) is found to sufficiently allow the first camera 2 (FIG. 2) to detect the preaddressed mailing device enough to provide an image of the preaddressed mailing device having the recipient indicia 31 to be displayed on the monitor 5 of the computer system 1. It is understood that any type of illumination source 9 can used while remaining within the scope of the present invention as long as the illumination source is capable of sufficiently illuminating the portion of preaddressed mailing device 12 upon which the recipient indicia 31 is disposed.

The second camera 3 is located at a different area of the mail insertion machine 11 (FIG. 5). More specifically, the second camera 3 is positioned such that the second camera can view the portion of the mailing insert 14 that includes a recipient indicia 32 (FIG. 7) of the mailing insert. The mailing inserts 14 (FIG. 2) are typically stored in a mailing insert staging area 19 in standard mail insertion machines 11. As in the case of the first camera 2, alternative embodiments of the present invention can include an illumination source 9 focused on the portion of the mailing insert that displays the recipient indicia 32 (FIG. 7) and the illumination source is intended to be mounted and located as needed to allow the second camera 3 (FIG. 2) to sufficiently detect the recipient indicia 32 for display on the monitor 5 of the computer system 1.

A preferred embodiment of the machine monitoring apparatus A the machine cycle monitoring device 4 (FIG. 2) is an encoding device that provides a signal to the computer system 1 to establish a timing arrangement that allows the first camera 2 to detect the preaddressed mailing device 12 while also allowing the second camera 3 to detect the matching mailing insert 14. In this embodiment where the machine cycle monitoring device 4 is an encoder, the encoder provides a signal to the computer system that relates to the position of a component of the mail insertion machine 11. More specifically, typical mail insertion machines 11 have at least one rotating shaft 15 that rotates one complete 360 degree revolution for each insertion of the preaddressed mailing device 12 into its matching mailing insert 14. The machine cycle monitoring device 4 of the present embodiment is installed in a manner that allows the machine cycle monitoring device to detect when the rotating shaft 15 has made one complete revolution or when the mail insertion machine 11 has completed one cycle of inserting one mailing insert 14 into one preaddressed mailing device 12, whichever method is necessary to provide the timing needed to allow the first camera 2 to capture the image of the mailing insert and the preaddressed mailing device into which the matching mailing insert is to be inserted.

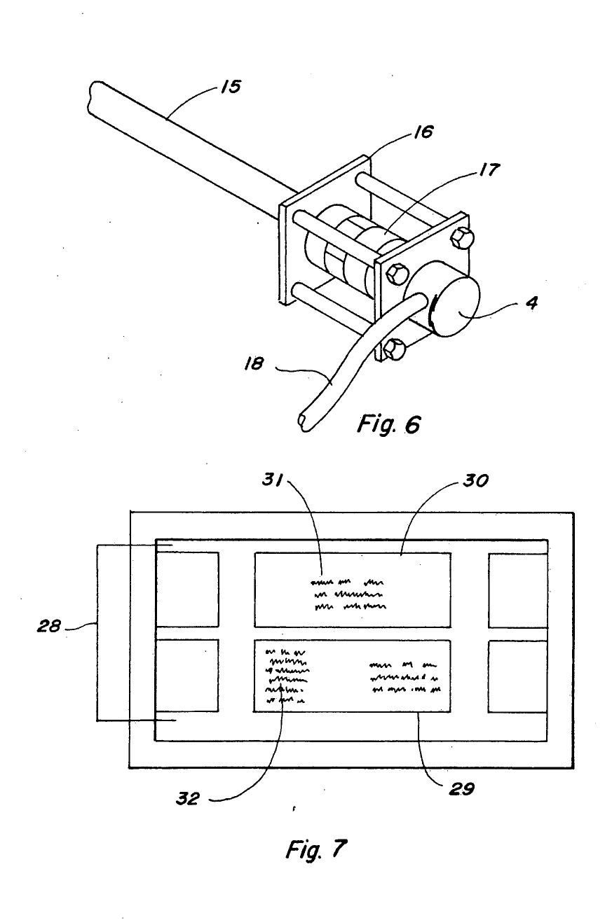

As shown in FIG. 6, the present embodiment of the machine monitoring apparatus A includes the physical attachment of the encoder device directly onto the end of the rotating shaft 15 through the use of a mounting bracket 16 and a shaft coupler assembly 17. It is understood that any device can be used to detect the revolution of the rotating shaft 14. For example, the combination of a switch mounted near the rotating shaft 14 and a switch trigger mounted onto the rotating shaft may be configured to allow the switch to be activated one time for each revolution of the rotating shaft. In other embodiments, an optical detection device may also be used wherein a signaling device is mounted onto the rotating shaft 15 in a manner that allows the optical detection device to detect the signaling device once for each rotation of the rotating shaft. In yet other alternative embodiments, the component of the mail insertion machine 11 that is monitored by the machine cycle monitoring device 4 is not a rotating shaft, but is any other element of the mail insertion machine that can be used to determine when the mail insertion machine has complete one cycle of inserting a mailing insert 14 into its matching mailing device 12. It is also noted that the element of the mail insertion machine this monitored by the machine cycle monitoring device 4 need not precisely match one cycle of the mail insertion machine. For example, a lever, a sliding plate, or a moving component may also be used as long as the mail insertion machine component to be monitored can be used to either directly or indirectly result in a determination of when one cycle of the mail insertion machine 11 has occurred. Additionally, any device can be used as the machine cycle monitoring device 4 and remain within the scope of the present invention as long as the device selected can provide a signal to the computer system 1 wherein the signal can be sued to determine directly or indirectly that the mail insertion machine has completed one cycle. In a preferred embodiment, the signal from the machine cycle monitoring device 4 is communicated to the computer system 1 by a cable that is attached to an interface device that converts the signal to one that is usable by the computer system. In other embodiments, the cable from the machine cycle monitoring device 4 can be connected directly to a PCI card that has been installed into the computer system. In yet other embodiments of the present invention, the signal can be communicated to the computer system 4 by use of electromagnetic communication. Thus, it will be appreciated by those skilled in the art that the machine cycle monitoring device 4 can communicate with the computer system 1 using any type of communication method that allows for the signal generated by the machine cycle monitoring device to be sufficiently received by the computer system.

In operation, the monitor 5 (FIG. 2 and FIG. 7) of the computer system 1 displays a set of monitoring images 21 that includes a first image 29 of a mailing insert 14 that is displayed substantially adjacent a second image 30 of a preaddressed mailing device. Based on the determination of one cycle of the mail insertion machine 11, it is intended that the first image 29 discloses the recipient indicia 32 of the mailing insert that generally matches the recipient indicia 31 of the mailing device disclosed in the second image 30. The operator manually reviews the set of monitoring images 21 to determine if indeed the recipient indicia 32 of the mailing insert 14 matches the recipient indicia 31 of the preaddressed mailing device 12. If those two recipient indicia 31 and 32 substantially match, then the operator can deduce that the mail insertion machine 11 is properly inserting the correct mailing insert 14 into its matching preaddressed mailing device 12. If the two recipient indicia 31 and 32 do not match, the operator can deduce that the mail insertion machine 11 is not working properly and that the mailing inserts 14 are not being inserted into its matching preaddressed mailing device 12. When that situation occurs, the operator can stop the mail insertion machine 11 to manually correct the insertion errors made by the machine and then adjust the mail insertion machine as needed such that the mailing inserts 14 are again synchronized with the matching preaddressed mailing device 12. After the mail insertion machine 11 has been resynchronized, the operator can then restart the mail insertion machine and continue monitoring the set of monitoring images 28 being displayed on the monitor 5 of the computer system 1.

The computer software package 8 of a preferred embodiment assists the operator in accomplishing these tasks by operating in conjunction with the computer system 1 and the other elements of the machine monitoring apparatus A. The computer software package 8 does this by capturing the signals from other signaling components of the machine monitoring apparatus A and sufficiently displaying the images obtained by the first camera 2 and the second camera 3 to allow an operator of the combined mail insertion machine 11 and machine monitoring apparatus A to verify that the mailing insert 14 is being properly matched by mail insertion machine with the matching preaddressed mailing device 12.

More specifically, the signal from the machine cycle monitoring device 4 is first tested during installation to ensure that timing of the signal received by the computer system 1 coordinates with one cycle of the mail insertion machine 11. If the signal does not coordinate with one cycle of the mail insertion machine 11, the machine cycle monitoring device 4 can be adjusted as needed to match that cycle or, in alternative embodiments of the present invention, the computer software packaged 8 can be programmed to use the signal obtained from the machine cycle monitoring device 4 to indirectly determine when the mail insertion machine as completed one cycle. This is to say, the computer software package 8 can include processes by which the signal received by the machine cycle monitoring device 4 can be adjusted internally within the software to sufficiently coordinate the timing of the signal with one cycle of the mail insertion machine.

The computer software package 8 signals the first camera 2 and the second camera 3 to capture images of the mailing insert 14 and the preaddressed mailing devices 12 by timing the first camera 2 and the second camera 3 to capture their images as needed to match one cycle of the mail insertion machine. It is understood that the computer software package may include some adjustment in the timing of the capture of the images from the first camera 2 and the second camera 3 as necessary to capture images that are more useful to the operator of the mail insertion machine 11. For example, in some embodiments better images might be obtained if the computer software package 8 instructs the first camera 2 to capture an image of the preprinted envelope 12 about 0.5 seconds after the computer system receives the signal from the machine cycle monitoring device 4. In a similar manner, the computer software package 8 can also instruct the second camera 3 to capture an image of the mailing insert 14 about 0.9 seconds after the computer system receives the signal from the machine cycle monitoring device 4. In alternative embodiments when the machine cycle monitoring device 4 is an encoder device that sends signals related to the rotational position of the rotating shaft 15 of the mail insertion machine 11, the computer software package 8 may send signals for the first and second cameras 2 & 3 to capture images at certain angular degrees of rotation of the rotating shaft.

This is to say, that in the various embodiments of the machine monitoring apparatus A, the timing for the capture of images from either the first camera 2 or the second camera 3 does not need to match the specific instant that the computer system 1 receives the signal from the machine cycle monitoring device 4, but may be adjusted by the computer software package as needed to ensure the images captured are of useful detail and quality for the operator of the mail insertion machine 11 to monitor and that the timing for the image capture ensures that the set of images from the cameras include an image of a specific mailing insert 14 that the mail insertion machine will insert into a specific preaddressed mailing device 12.

In a preferred embodiment of the machine monitoring apparatus A, the computer software package 8 includes processes by which the operator of the mail insertion machine 11 can adjust the information displayed on the monitor 5 to allow for the best display of information necessary to allow the operator to monitor the mail insertion machine. For example, most mail insertion machines 11 are high volume devices that operate at a very fast cycle rate that can include tens or even hundreds of cycles per minute, with each cycle including the process of inserting one mailing insert 14 into one preaddressed mailing device 12. If the monitor displayed each and every set of images that could be captured by the first camera 2 and the second camera 3, the operator would be unable to properly verify the operation of the mail insertion machine 11 because the operator's eyes would not be able to detect and verify the information being displayed. To alleviate this problem, the computer software package 8 can include a set of processes that includes a display increment by which the operator of the mail insertion machine 11 can adjust the computer system 1 to display images on the monitor 5 that are more useful to the operator. For example, the display increment can be set such that the computer system will display only every fifth set of monitoring images, or every tenth set of monitoring images, or whatever display increment best allows the operator of the mail insertion machine 11 to have sufficient time to examine the information shown in the set of monitoring images 28 to allow the operator to determine if the mail insertion machine is functioning properly.

Therefore, in preferred embodiments of the present invention, the computer software package 8 and computer system 1 comprise at least some of the following operations, settings, and adjustments as needed for the particular embodiment of the machine monitoring apparatus A being used:
a. The ability to adjust various characteristics regarding the quality of the set of monitoring images 21 displayed on the monitor 5 such as the contrast, brightness, color, sharpness, orientation of the images on their rotation axis (upside down, sideways, etc.);
b. The orientation of the set of monitoring images 21 as displayed on the monitor 5 can be adjusted such that the image of the mailing insert 14 can be displayed above, along side, below, or in other configurations as needed by the operator to allow the operator to best monitor the set of monitoring images 28;
c. The timing of which set of monitoring images 28 will be captured by the first camera 2 and the second camera 3 for display on the monitor 5. For example, the operator may wish to only view a set of monitoring images 28 for every 10 cycles of the mail insertion machine 11, with the cycle increment being variable by the operator through adjustment of the computer software package 8 made by the entering of information by the operator of the mail insertion machine into the computer system 1 through using the input device 6;
d. The timing of when each set of monitoring images 28 taken by the first camera 2 and the second camera 3 will be displayed on the monitor 5;
e. The general location of the cameras installed on the machine monitoring apparatus A and which camera is to be the first camera 2 and the second camera 3, as well as the designation and use of any other cameras that may have been incorporated into an embodiment of the machine monitoring apparatus A;
f. The ability to turn on the cameras before the mail insertion machine 11 is in full operation to thereby capture either still or live images of the set of monitoring images 21 being captured by the first camera 2 and the second camera 3;
g. The ability to size and zoom in or out of each of the images from the set of monitoring images 28;
h. The ability to adjust how much time each of the images from the set of monitoring images 28 is displayed on the monitor 5.
i. The ability to display previous sets of monitoring images 28 in a manner that will allow the operator of the mail insertion machine 11 to be able to look at the previous operation of the mail insertion machine to determine when the synchronization between the mailing insert 14 and the preaddressed mailing device 12 may have become unsynchronized in a manner that allowed an incorrect mailing insert to be inserted into a preaddressed mailing device having a recipient indicia 31 that did not match the recipient indicia 32 of the mailing insert. This gives an indication to the operator of the mail insertion machine 11 an idea of how many unmatched mailing inserts 14 and preaddressed mailing devices 12 have been incorrectly combined;
j. The ability to display the resolution and frame rate of the cameras used in any particular embodiment of the machine monitoring apparatus A;
k. The ability to display the raw values provided by the machine cycle monitoring device 4. Depending upon the particular embodiment of the machine monitoring apparatus A, the raw values can be in rotational degrees, radians, or any other increment that can be used to directly or indirectly determine when the mail insertion machine 11 has completed one cycle;
l. The intensity of the illumination of any illuminating devices 9 may also be adjusted by the operator;
m. The ability to display on the monitor 5 what is the average speed in insertions per a time frame at which the mail insertion machine 11 is operating;
n. The ability to operate the machine monitoring apparatus A in conjunction with a mail insertion machine 11 that is operating at a rate of about 7,000 insertions per hour; and,
o. Allow for the saving of new settings or the use of predetermined and preset settings for each of the above.

As described above, the various embodiments of the machine monitoring apparatus A provide an efficient method of monitoring the operation of a mail insertion machine 11 that is simple, this is lower cost than other previous methods, and that is more readily adaptable for installation on existing mail insertion machines without the need for extensive and costly modifications of the mail insertion machine.

While the above description describes various embodiments of the present invention, it will be clear that the present invention may be otherwise easily adapted to fit any configuration where a machine monitoring apparatus is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

What is claimed is:

1. A machine monitoring apparatus comprising:
at least a first camera providing a first image;
at least a second camera providing a second image;
a computer system comprising a monitor and a computer input device;
at least one machine cycle monitoring device capable of determining the operational position of a component of a monitored machine wherein the machine cycle monitoring device is capable of providing information to the computer system to thereby coordinate a set of monitoring images for display on the monitor wherein the set of monitoring images includes the first image and the second image;
a computer software package operating in cooperation with the computer system that is capable of accepting a first image signal, a second image signal, and the signal from the machine cycle monitoring device to thereby display the set of monitoring images in a manner that provides information to an operator of the monitored machine to determine if the monitored machine is operating properly.

2. The machine monitoring apparatus of claim 1 further comprising a set of interconnecting communication capabilities that is provided by one of either electrical conductors or electromagnetic wave communicators.

3. The machine monitoring apparatus of claim 2 wherein the monitored machine is a mail insertion machine.

4. The machine monitoring apparatus of claim 3 wherein the first camera is installed in a manner that allows the first camera to capture the first image wherein the first image includes a portion of a preaddressed mailing device that includes a recipient indicia of the preaddressed mailing device.

5. The machine monitoring apparatus of claim 4 wherein the second camera is installed in a manner that allows the second camera to capture the second image wherein the second image is an image of a portion a mailing insert that includes a recipient indicia of the mailing insert.

6. The machine monitoring apparatus of claim 5 wherein the at least one machine cycle monitoring device is a device that provides a signal to the computer system that can be used to one of either directly or indirectly allow the computer system and t the computer software package to establish a timing arrangement for when the first camera captures the first image and the second camera to captures the second image and to determine when the mail insertion machine completes a mail insertion machine cycle.

7. The machine monitoring apparatus of claim 6 wherein the encoder provides an encoder signal to the computer system that relates to the position of a component of the mail insertion machine.

8. The machine monitoring apparatus of claim 7 wherein the component of the mail insertion machine is a rotating shaft and the encoder signal relates to the rotational position of the rotating shaft.

9. The machine monitoring apparatus of claim 8 wherein the rotating shaft that rotates one revolution for each mail insertion machine cycle.

10. The machine monitoring apparatus of claim 9 wherein the mail insertion machine cycle includes the single insertion of one mailing insert into one preaddressed mailing device such that the recipient indicia of the mailing insert is intended to match the recipient indicia of the preaddressed mailing device.

11. The machine monitoring apparatus of claim 10 wherein the computer software package further comprises an adjustment process by which the timing of the capture of the first image from the first camera can be adjusted as needed to allow the first camera to capture the first image such that the first image is of sufficient quality for an operator of the mail insertion machine to read the recipient indicia of the preaddressed mailing device.

12. The machine monitoring apparatus of claim 11 wherein the computer software package further comprises an adjustment process by which the timing of the capture of the second image from the second camera can be adjusted as needed to allow the second camera to capture the second image such that the second image is of sufficient quality for the operator of the mail insertion machine to read the recipient indicia of the mailing insert.

13. The machine monitoring apparatus of claim 12 further comprising at least one illumination source to provide the illumination required to properly display items detected by the first camera and the second camera on the monitor.

14. The machine monitoring apparatus of claim 12 wherein at least one of either the first camera and the second camera is a video camera.

15. The machine monitoring apparatus of claim 14 wherein the computer software package includes a set of processes by which the operator of the mail insertion machine can adjust the computer system to display images on the monitor that are most useful to the operator wherein the set of processes include at least one of either: (a) the ability to adjust a set of display characteristic of the set of monitoring images including contrast, brightness, and color of the set of monitoring images; (b) the ability to adjust a display increment for the set of monitoring images wherein the display increment includes the value related to whether every set of monitoring images will be displayed on the monitor or whether the set of monitoring images will be displayed on the monitor only after the mail insertion machine has run a specific number of cycles and the set of displayed monitoring images will be related to the most recent cycle of the mail insertion machine; (c) the ability to adjust the timing of when each set of monitoring images taken by the first camera and the second camera will be displayed on the monitor; (d) the ability to adjust the orientation of the set of monitoring images displayed on the monitor such that the first image of the preaddressed mailing device can be displayed one of either above, along side, adjacent, or below the second image of the mailing insert; (e) the ability to adjust the intensity of the illumination of the illuminating device; (f) to display information on the monitor that allows the operator to determines the general location of the first camera and the second camera installed on the machine monitoring apparatus as well as the location and use of at least one additional camera that may have been incorporated into an embodiment of the machine monitoring apparatus; (g) the ability to turn on at least one of either the first camera or the second camera before the mail insertion machine is in full operation to thereby capture one of either still images or live images being captured by at least one of either the first camera or the second camera; (h) the ability to adjust the orientation of set of monitoring images displayed on the monitor such the set of monitored images may be viewed one of either upright, upside down, sideways, or diagonal; (i) the ability to one of either size the set of monitored images, zoom in on the set of monitored images, or zoom out of the set of monitored images; (j) the ability to adjust how much time each of the set of monitored images is displayed on the monitor; (k) the ability to display previous sets of monitoring images in a manner that will allow the operator of the mail insertion machine to be able to determine if the operation of the mail insertion machine is functioning properly; (l) the ability to display a resolution and a frame rate of the first camera and the second camera; (m) the ability to display a raw value related to the signal provided by the machine cycle monitoring device; (n) the ability to display a speed related to the number of cycles the mail insertion machine is operating within a selected time frame; (o) the ability to sufficiently operate the machine monitoring apparatus when the mail insertion machine is operating at a rate of about 7,000 cycles per hour; and, (p) the ability to save new settings or the use of predetermined or preset settings for each of the above.

16. A machine monitoring apparatus comprising:
at least a first video camera providing a first image of a portion of a mailing insert that includes a recipient indicia for the mailing insert;
at least a second video camera providing a second image of a portion of a preaddressed mailing device that includes a recipient indicia for the preaddressed mailing device;
a computer system comprising a monitor and a computer input device;
at least one machine cycle monitoring device capable of determining the rotational position of a rotating shaft of a mail insertion machine wherein the machine cycle monitoring device is capable of providing information to the computer system to thereby directly or indirectly coordinate a set of monitoring images for display on the monitor wherein the set of monitoring images includes at least the first image and the second image;
a computer software package operating in cooperation with the computer system that is capable of accepting a first image signal from the first video camera, a second image signal from the second video camera, and the signal from the machine cycle monitoring device to thereby display the set of monitoring images in a manner that provides information to an operator of the mail insertion machine to compare the recipient indicia of the mailing insert to the recipient indicia of the preaddressed mailing device to ensure that the mail insertion machine is inserting mailing inserts into preaddressed mailing devices that have substantially the same recipient indicia of the mailing insert.

17. The machine monitoring apparatus of claim 18 wherein at least one of either the computer system or the computer software package includes an ability to adjust the time at which the first image and the second image are captured in relation to an operational speed of the mail insertion machine, an ability to adjust which set of monitored images are to be displayed on the monitor, and further comprising an ability to adjust characteristics related to how the set of monitored images are displayed on the monitor.

18. A machine monitoring apparatus comprising:
means for capturing an image of a mailing insert and an image of a preaddressed mailing device to be manipulated by a mail insertion machine;
means for determining when the mail insertion machine has completed a complete cycle of inserting the mailing insert into the preaddressed mailing device that has substantially the same recipient as the mailing insert; and
means for displaying the image of the mailing insert adjacent to the image of the preaddressed mailing device to sufficiently allow an operator of the mail insertion machine to determine that the mail insertion machine is operating properly.

19. The machine monitoring apparatus of claim 18 further comprising means for adjusting a timing value related to when the image of the mailing insert is captured and when the image of the preaddressed mailing device is captured where such timing value is related to the cyclic operation of the mail insertion machine.

20. A process of monitoring a mail insertion machine comprising the steps of:
using a video camera to capture a first image of a portion of a mailing insert upon which a recipient indicia for the mailing insert is disposed;
using a video camera to capture a second image of a portion of a preaddressed mailing device upon which a recipient indicia of the preaddressed mailing device is disposed;
incorporating means for timing a moment at which the first image is captured and the second image is captured; and
displaying the first image and the second mage on the monitor of a computer system such that an operator of the mail insertion machine can determine if the recipient indicia of the mailing insert is substantially the same as the recipient indicia of the preaddressed mailing device.
